(19) United States
(12) Patent Application Publication
(10) Pub. No.: US 2005/0050324 A1
(43) Pub. Date: Mar. 3, 2005

(54) Administrative system for smart card technology

(76) Inventors: David Corbett, Eagan, MN (US); Todd Steel, St. Paul, MN (US); Jeff Blaiser, Hudson, WI (US); Steve Adams, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/888,082

(22) Filed: Jul. 7, 2004

Related U.S. Application Data
(60) Provisional application No. 60/485,284, filed on Jul. 7, 2003.

(51) Int. Cl. H04L 9/00

(52) U.S. Cl. 713/168

(57) ABSTRACT

The invention provides a system configured to function with medium used for securely storing information. The system is designed to be used by an administrator, and the medium is designed to be used by an end-user. The system creates schemes that are distributed to the end-users. The schemes can be designed with the system to automate log-on processes for secured applications. In addition, the schemes can be designed with the system to automate password changes that are requested by the secured applications.

### CROSS-REFERENCE TO RELATED APPLICATION

This patent incorporates by reference in its entirety and claims priority to the entire contents of U.S. Provisional Application Ser. No. 60/485,284, filed Jul. 7, 2003.

### TECHNICAL FIELD

A medium used for securely storing information is provided. Systems are provided that are configured to function with the medium and the information stored thereon.

### BACKGROUND OF THE INVENTION

Providing and maintaining security for private information in today's corporate world is of utmost importance. Such private information may involve different things for different parties. For example, the information could involve product design information for engineering firms, or customer credit information for banking establishments. Even with the importance of keeping such information secure, some form of access typically needs to be provided to certain designated people. Regarding the examples above, engineers and bank employees would typically need access to the corresponding private information in order to perform their job duties. As such, there exists a delicate balance between keeping the private information secure, yet providing enough access to the information for persons that have been approved for such, without undue inconvenience.

A common way to provide a person access to private information stored in a secure system is by having the person initially log on to the system using certain authentication information. By having the person log on to the system, a preliminary security check can be made before access is given to the person. Generally, the log-on involves the person typing in a username as well as a password, however, it could also just involve typing in a pin number or a pass phrase. While this method is generally considered an acceptable way to provide security for these systems, drawbacks are presented, particularly for persons who typically need to log on to a plurality of such secured systems.

As mentioned above, in order to log on to each of the plurality of secured systems, the person logging on would typically need to remember one, and probably more than one, passwords. In all likelihood, one password could not be used for all the systems, as each of the systems would probably have differing allowed password parameters in place. As such, the person would generally need to remember multiple passwords. It is often the case that the user physically writes the passwords down (or stores the password, on a hard drive, for example) so that the one or more of the passwords are not forgotten over time. However, by writing or storing the passwords, the method of keeping the system information secure is compromised, as the user may lose the password list, or another unapproved person may intentionally take the written list (or the information tabulated thereon) or otherwise gain unauthorized access to the stored passwords to gain system access.

Additionally, even if the initial passwords are written down, most of these systems also require users to change their passwords regularly for additional security purposes. Accordingly, the users would need to regularly update their written or stored list. Unfortunately, this may further complicate matters as users may confuse their updated passwords with their previous passwords. Further, when passwords are changed, the user may simply create a new list and subsequently, dispose of the old list. In this scenario, unless all the passwords are changed prior to disposing the list, the authentication information may once again be compromised, as the disposed list would likely contain one or more current passwords that could still be used by persons not approved for access to such systems.

Amongst others, these problems are addressed by the invention.

### SUMMARY OF THE INVENTION

Certain embodiments of the invention provide a system for managing user access to one or more secured applications. The system comprises at least first and second processing devices, one or more portable access devices, and an access scheme. The one or more portable access devices have information stored therein, and each portable access device is adapted to facilitate two-way communication with the first processing device. The access scheme is adapted to be configured with one of the first and second processing devices and is adapted to be “enrolled,” i.e. provided user-specific authentication information for a computing resource that the access scheme has been “trained on,” or “taught about”, and accordingly recognizes and knows where to provide the enrolled authentication data. The enrollment will follow the configuration implemented with the first processing device. Following such configuration and enrollment, the access scheme is adapted to facilitate user access to the one or more secured applications when used with the first processing device.

In addition, certain embodiments of the invention provide a system for managing and authenticating user identity to one or more secured applications. The system comprises at least first and second processing devices, one or more portable access devices, and an access scheme. The one or more portable access devices have information stored therein, and each portable access device is adapted to facilitate two-way communication with the first processing device. The access scheme is adapted to be configured with one of the first and second processing devices and is adapted to be enrolled following such configuration with the first processing device. Following such configuration and enrollment, the access scheme is adapted to change the information stored in the access devices when necessitated by the one or more secured applications when used with the first processing device. This change may be effected in a manner that is transparent (i.e., unseen) to the user.

Also, certain embodiments of the invention provide a method of creating a system to centrally manage user access to one or more secured applications. The method comprises providing at least first and second processing devices. The method also includes providing one or more portable access devices having information stored therein. Each portable access device is adapted to facilitate two-way communication with the first processing device. The method also includes configuring an access scheme with one of the first and second processing devices. The access scheme is adapted to be enrolled following such configuration with the first processing device. Following such configuration and enrollment, the access scheme is adapted to facilitate user access to the one or more secured applications when used with the first processing device.

Further, certain embodiments of the invention provide a method of creating a system to manage user access to one or more secured applications. The method comprises providing at least first and second processing devices. The method also includes providing one or more portable access devices having information stored therein. Each portable access device is adapted to facilitate two-way communication with the first processing device. The method also includes configuring an access scheme with one of the first and second processing devices. The access scheme is adapted to be enrolled following such configuration with the first processing device. Following such configuration and enrollment, the access scheme is adapted to change the information stored in the access devices when necessitated by the one or more secured applications when used with the first processing device.

### BRIEF DESCRIPTION OF THE DRAWINGS

FIG. 1 is an enlarged front view of a smart card in accordance with certain embodiments of the invention;

FIG. 2 is a diagram illustrating steps undertaken to implement an administrative system for smart card technology in accordance with certain embodiments of the invention;

FIG. 3 is a software architecture diagram illustrating the software components of an administrative system in accordance with certain embodiments of the invention;

FIG. 4 is a front view of a computer screen shot of a management center home page from the administrative system software in accordance with certain embodiments of the invention;

FIG. 5 is a flow diagram illustrating the functioning of a management center from the administrative system software in accordance with certain embodiments of the invention;

FIG. 6 is a flow diagram illustrating the functioning of an enrollment process from user-defined access schemes in accordance with certain embodiments of the invention; and

FIG. 7 is a front view of a computer screen shot illustrating an enrollment process home page from a user-defined access scheme in accordance with certain embodiments of the invention.

FIG. 8 is a state diagram of a configuration module according to embodiments of the invention presented as pseudo-code.

FIG. 9 is a state diagram of a login handling module for an application computing resource according to embodiments of the invention presented as pseudo-code.

FIG. 10 is a state diagram of a login handling module for a browser-implemented computing resource according to embodiments of the invention presented as pseudo-code.

### DETAILED DESCRIPTION OF PREFERRED EMBODIMENTS OF THE INVENTION

The following detailed description is to be read with reference to the drawings, in which like elements in different figures have like reference numerals. The drawings, which are not necessarily to scale, depict selected embodiments, but are not intended to limit the scope of the invention. It will be understood that many of the specific details of the invention illustrated in the drawings could be changed or modified by one of ordinary skill in the art without departing significantly from the spirit of the invention. The system of the invention is designed for use in all sizes of commercial companies as well as government (US, state, local and foreign) and non-profit agencies. Generally, if the system of the invention is used with a network, it may be used on any network system in which access to secured applications is enabled primarily via the use of passwords.

In certain embodiments of the invention, access devices are used as mechanisms to store information (e.g., log on information, digital credentials, etc.) These access devices can be portable. In certain embodiments, these access devices can be smart cards. While embodiments described herein depict smart cards as being used with the system of the invention, it should be appreciated that this is for convenience of illustration and not done so as to limit the scope of the invention. Thus, the smart cards, as referenced herein, should only be interpreted as one of many access devices that could be embodied with the system of the invention. Smart cards are available in many forms. One preferable form involves the smart card resembling a typical credit card, with similar size, shape, and weight; however, other embodiments may also be utilized, e.g., in which a USB (Universal Serial Bus) token is utilized. The USB token (i.e., a small, lightweight device that can fit on a key-ring) provides the same smart card technology as the credit card-like form, however eliminates the need for a separate interface, such as a card reader. As will be described below, smart cards contain internal programmable memory that enables the storage of information thereon. By logging on to the card (e.g., by the user providing a pass phrase), the user is enabled to gain access to the information stored on the card, which, in turn, can be used to gain access to one or more restricted systems. In certain embodiments in which the smart card resembles a typical credit card, the card is placed into a reader that is operatively coupled to a processing device, e.g., a personal computer (PC). Upon insertion of the card, the user subsequently is prompted by the processing device to enter a smart card pin number or passphrase in order to log on to the card. Once the appropriate number or password is entered, the user, via the processing device, is given access to all the stored information on the card.

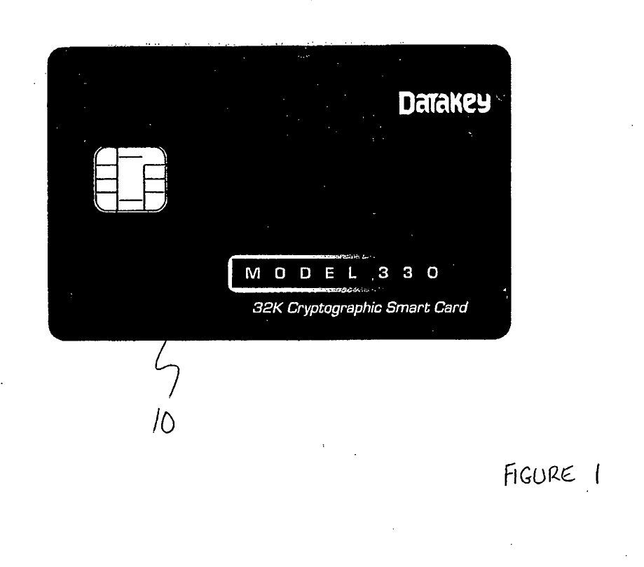

FIG. 1 illustrates an enlarged front view of a smart card 10 in accordance with certain embodiments of the invention. As previously mentioned, the smart card 10 is a small hardware device that is used to store information, e.g., log-on information, digital credentials, etc. Preferably, the stored information includes user names, passwords, domain names, digital certificates, public/private keys, personal information, and the like. As shown, the smart card 10 is commercially available from Datakey Inc. (Minneapolis, Minn., USA). The smart card 10 may be referred to herein as an authentication token because with the stored private information, the card 10 can, in turn, be used to authorize access to protected applications. Preferably, at least some portion of the information stored on the smart card 10 cannot be accessed unless the owner of the smart card logs on to the smart card using the proper passphrase. Thus, the information on the smart card, as well as access to secured applications, is protected by two-factor security, something that is owned (i.e., the smart card 10) and something that is known (i.e., the smart card passphrase or PIN).

Generally, the smart card has a multitude of features. In preferable embodiments, some of the features include having a built-in, ROM-based, crypto/security application, which utilizes high performance cryptographic functions, performs certificate storage and handling, and provides support for multiple keys and certificates. Additional features of the smart card may include having certification through FIPS (Federal Information Processing Standards) 140-2 Level 2, and support of PKCS #11 and Microsoft Crypto API interface requirements, which enable the card to be used to secure email and to act as an authentication tool. Further, the smart card preferably has built-in 32K EEPROM for secure storage, which allows for storage of up to 30 certificates, depending on the size of the digital profile. Finally, in certain embodiments, the smart card may utilize on-card key generation thus displayed on an LCD screen, thereby preventing the critical private key from being stolen over a network or from a user's PC; may support multiple encryptions algorithms including RSA, DES, and Triple DES; may support Secure Hash Algorithm (SHA-1) and Digital Signature Algorithm (DSA); and may provide protection against differential power and timing attacks.

An administrative system is described herein to function with the smart card technology described above. The administrative system may be referred to as herein under the trademark Datakey™ Axis™. A system according to present invention may be used with or integrated with smart card control software such as that commercially available from Datakey Inc. of Minneapolis, Minn. One feature of the system involves access control (e.g., managing the log-on process for users in regard to certain applications). Another feature of the system, which can be used in combination with the access control functionality, involves identity management (e.g., managing the update of passwords in regard to certain applications), which can be sued in combination with the access control functionality. While smart cards provide secure access for username, passwords, certificates, private keys and other digital credentials, the system preferably works in conjunction with the smart cards to automatically retrieve and enter such information whenever a properly authenticated user attempts to access a secured application. These secured programs include but should not be limited to utilities, network programs, web pages, computer systems, networks, and even physical structures. In certain embodiments of the invention, the user is automatically prompted by the administrative system to provide authenticating information (e.g., a pass phrase) before access is given to the information stored on the smart card. Generally, the system can be used to relieve the user from remembering the passwords needed for each secured application. The system can also be used to create new passwords for the secured applications for the user and store them on the smart card when necessitated by the secured applications.

In preferable embodiments, the administrative system is made to work in conjunction with the access devices and the secured applications through the creation and distribution of one or more user-defined access schemes. Each access scheme can be referred to as a policy client. A configuration procedure is followed in creating the access scheme to enable the scheme to recognize the secured applications and their corresponding logon dialogue box fields. This configuration can be implemented by an administrator using the system software. Following such configuration, each access scheme can be configured to be deployable via a network to one or more end users' processing devices, e.g., PCs. Such access schemes may be created in .msi (Microsoft Installer) file format to enable automatic deployment. In certain embodiments, after being deployed, an enrollment procedure is followed to enable the access scheme to function with the one or more end-users' smart cards when used with the one or more processing devices. Upon the completion of the enrollment process per user, the access scheme is enabled to recognize which information stored on the smart cards needs to be correspondingly entered in to the log on dialogue box fields of the secured applications to gain access to such applications as permitted to that user. Upon such configuration and enrollment procedures, the access scheme is adapted to automate the log-on process. Further, the scheme can be similarly configured and enrolled concurrently or separately to automate password update processes. While certain embodiments described above involve deployment of the access schemes over a network, the schemes could be distributed without a network. For example, the access schemes could be copied to a portable storage mechanism (e.g., CD-ROM) and manually carried to the end users' processing devices for installment. In addition, the access schemes may also be created on the end users' processing devices, thus requiring no deployment or distribution of the schemes thereafter. The creation of the schemes does not involve any interim manual processes that an administrator must perform or impose any scripting requirements from the administrator. The training is may be accomplished with an easy drag and drop process, as is described further below.

One problem addressed by the administrative system according to the present invention is the need to simplify the deployment and use of security solutions, and to further provide an end-user with enhanced security that is cost-efficient. Typically, security products add administrative burden, as well as extra burden onto the actions of the end user. Prior solutions rely mainly on scripting techniques to setup new applications to manage logins for users. Although it may be a simple task for a developer to learn a scripting language, it is often non-trivial for a medium size corporate IT administrator to learn a new scripting language. Conversely, the administrative system of the invention uses a simple and familiar technique to set up applications, the so-called “drag-and-drop” technique. In this implementation, each access scheme is configured by simply dragging and dropping an icon target from the log-on dialogue box fields of the secured applications to be recognized in the future; for example, the text fields requiring user name and password for a particular application. By noting dialog box parameters, such as resource ID, programmed name, or coordinate position within a process, window, or HTML page, the access scheme is configured to remember details about the dialogue boxes and the login behavior. In this way, knowledge if scripting languages if by the novice administrator is not necessary. Subsequently, each access scheme is “enrolled” on a per user and even on a per-resource basis, for example, by using the scheme with the processing device during the manual log on procedures with the secured applications. Additionally, all the recognized application's login information can be securely stored on a powerful smart card with tamper-resistance features. This system is an improvement from prior solutions for login management. Other solutions require a server component to be configured whereas the system described herein does not. Prior solutions require the client machine hard disk to store encrypted login information, which generally makes it vulnerable. Furthermore, prior solutions that store login information on the hard disk only work on that workstation and therefore eliminates the portability aspect that can be provided if the login information is stored on the smart card as is the case with the system described herein.

In certain embodiments, each user-defined access scheme includes a database that enables an automatic recognition of each application login screen of a secured application, a retrieval of the appropriate username and password from the smart card for the log-on screen, an automatic insertion of the username and password into appropriate log-on dialogue boxes, and then an automatic submission of the information. Likewise, each scheme can have the ability to automatically recognize a change password request screen of a secured application, generate a new password for the user, and save it on the smart card in place of the prior password used for that secured application for future use. With both these mechanisms, the user no longer needs to remember passwords and/or create new passwords. If both mechanisms are used, the user only needs to remember the passphrase (or PIN) to log on to the smart card. Once logged on to the smart card, the user has all system log-ons and all future password changing done automatically.

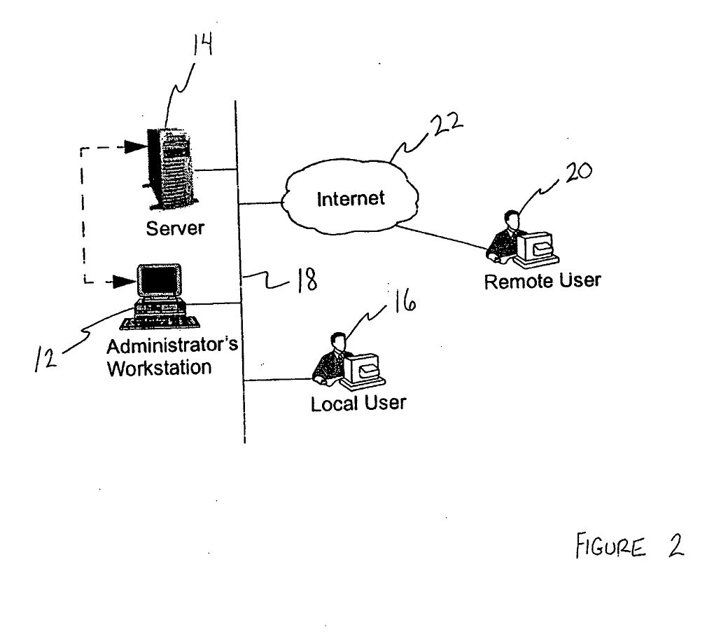

FIG. 2 shows a diagram illustrating steps undertaken to implement the administrative system. In certain embodiments, the system enables the administrator to build a security structure for secured applications (e.g., corporate-based) that corresponding end-users may only gain access to via their access device (e.g., smart cards) and their processing device (e.g., PCs). One particular embodiment of the system implementation is initiated by installing the system software (not depicted) onto an administrator's workstation 12. Once installed, the administrator uses the system software to create one or more of the user-defined access schemes for the end-users. This is generally done at the workstation 12 or at a central server 14. Finally, the one or more access schemes created are preferably deployed to the end-user workstations, whether local 16 via a local network 18 or remote 20 via the Internet 22. While there is only a single workstation illustrated for each of the local user 16 and the remote user 20, the one workstation may represent one or more workstations, and is not meant to limit the invention. It is also contemplated that the single workstations 016, 20 may also represent groups of end-users. Further, as mentioned previously, the schemes can be distributed without a network (18 or 22), for example, by physical distribution of a media, for example, via portable storage medium, such as a CD-ROM. Finally, the system software can be installed at the end user workstations 16 or 20 directly, thus eliminating the need for distributing the access schemes after being configured.

The administrator workstation 12 may be implemented with hardware containing a Pentium or later processor, 16 Mbytes of RAM, and one of either an available serial port with a smart card reader, an available PCMCIA slot with a laptop computer, or an available USB port and USB smart card. The administrator workstation 12 may have software containing a Microsoft operating system, such as Windows 2000® or a Windows XP Professional®, available from Microsoft Corporation of Redmond, Wash., U.S.A., in order to install the system. Additionally, the workstation 12 may contain a Microsoft Windows™ networking infrastructure including access to an Active Directory if deploying one or more user-defined access schemes, a network connection to the end-users if deploying one or more user-defined access schemes, RRAS (for remote access), and a Microsoft Calif. (Certificate Authority) for use with a PKI (Public Key Infrastructure).

Each of the end-user workstations 16, 20 may be implemented using hardware containing a processor, e.g. a Pentium or later processor, ideally having 16 Mbytes of RAM, and one of either an available serial port with a smart card reader, an available PCMCIA slot with a laptop computer, or an available USB port and a USB smart card. Each of the end-user workstations 16, 20 may have software containing an operating system such as a Microsoft operating system, preferably either Windows 98® (requires Active Directory Services Interface (ADSI)), Windows 2000® or a Windows XP Professional®, or Windows NT® 4.0 Desktop with Service Pack 6a or higher, in order to install the system. Additionally, each of the workstations 16, 20 may contain a network connection for automated deployment.

The administrative system may be used with smart cards, including the Model 330 and Model 330g smart cards as well as the Model 330j Java card, commercially available from Datakey Inc. (Minneapolis, Minn., USA). Additionally, the system would support the Rainbow iKey 2032 USB token. Acceptable readers would include Datakey DKR 711 (PC/SC) Serial Port Smart Card Reader, Datakey DKR 700 (PC/SR) PCMCIA Smart Card Reader, and Datakey DKR 730 (PC/SC) USB Port Smart Key Reader. These readers are also commercially available from Datakey Inc.

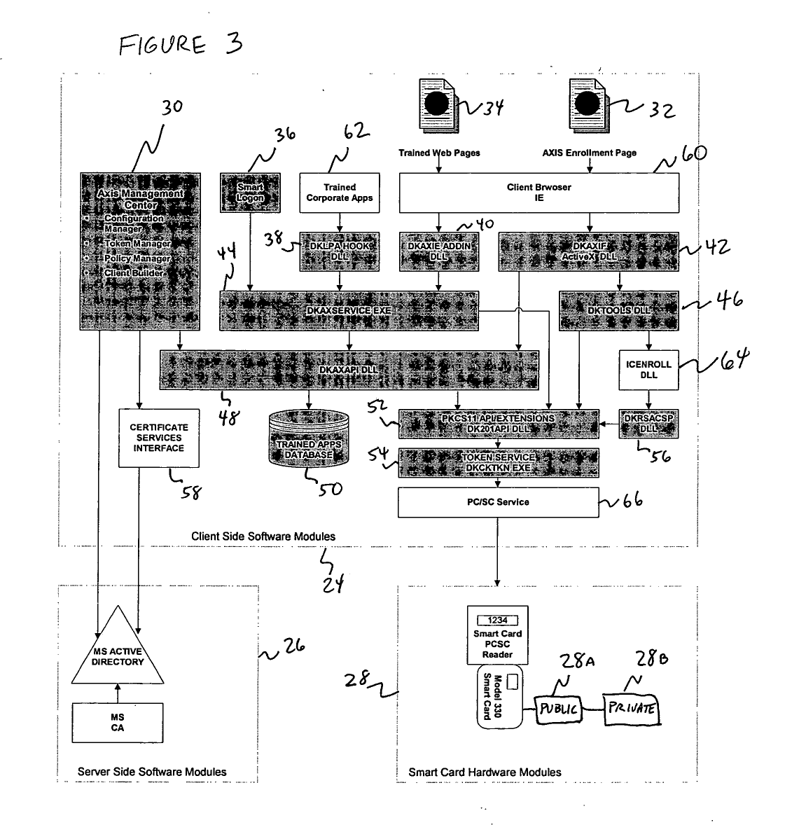

As described above, the administrative system software is installed onto the administrator's workstation 12, preferably via CD-ROM. Once installed, the one or more user-defined access schemes can be created using the software. One particular embodiment of an architecture diagram of the software is shown in FIG. 3. The diagram lays out a plurality of software elements 30 through 66. While being represented in FIG. 3 and described herein in terms of their functionality, the software elements generally involve one or more sections of one or more computer programs of the software package of the administration system. It should be appreciated that there are a number of different ways and fashions in which the software package of the administrative system could be represented, and that this illustrated and described architecture diagram merely represents one such representation. The diagram includes client side software modules 24, server side software modules 26, as well as smart card hardware modules 28. Smart card hardware module 28, consisting of a smart card reader and smart card, also contains storage elements 28A and 28B, depicted as logical and separate memory modules in FIG. 3, but in fact residing physically on the smart card of the hardware module 28, such as in EEPROM type memory or non-volatile RAM. As indicated, the logical memory modules may be divided into Public module(s) 28A and Private module(s) 28B. Public logical module 28A may be readable by any person having access to the card as integrated (i.e. inserted into a reader of the Smart Card Hardware Module 28, while private logical module 28B may be configured to be accessed upon entry of a PIN to the Hardware Module 28, which operates to effect an “unlocking” of the private module 28B. The administrative system software is represented by all elements included as client side software modules 24. Of these client side software modules 24, the shaded software elements 30 and 36-48, are generally developed to work in conjunction with elements 58 through 66 of the client side software modules 24 and the server side software modules 26 (which may be preexisting Microsoft Windows™ and/or other third-party system components).

Two major elements of the administrative system software include the Axis Management Center module 30, which is utilized in the configuration procedures when creating the access schemes, and the Axis Enrollment (Web) page 32, which may be utilized in the enrollment procedures when further creating the access schemes. Upon such configuration and enrollment, the access schemes are adapted to function with the end-user's smart card by saving access information for secured applications on the smart card and automatically retrieving the information on the smart card when necessitated by the secured applications. Additionally, the access schemes may be adapted to automatically change passwords when necessitated by the secured applications, and store these on the smart card. The enrollment page 32, implemented using software, may alternatively use another GUI or command line interface, and may be referred to as a “page” or “module”. The other shaded software elements 36 through 56 are used by the module 30 and the page 32 in their operation. As depicted in FIG. 3, these modules may be implemented as DLL files when the present invention is implemented for use with a Microsoft operating system. Such dynamic link library files do not need to be loaded into RAM with the main application, but can be called when needed at run time. All of the software elements 30 through 56 of the client side software modules 24 making up the administrative system serve functions as described herein.

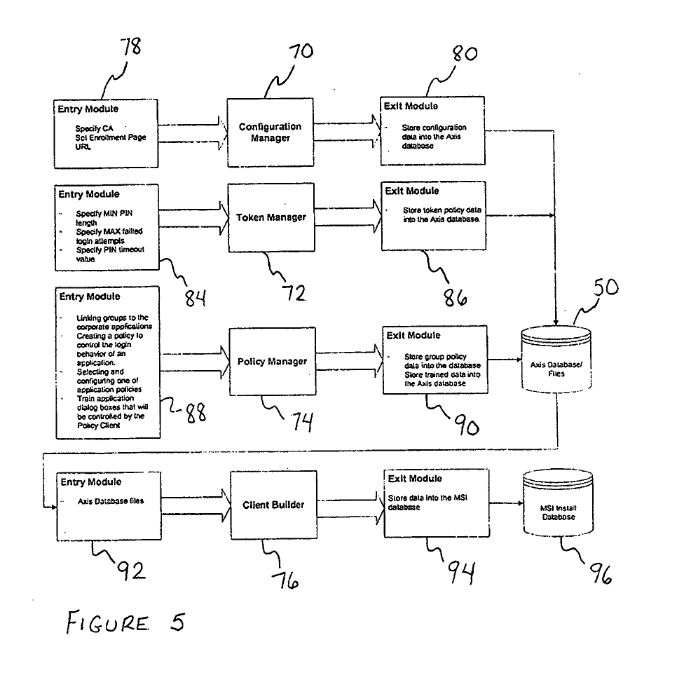

In certain embodiments of the invention, the module 30 is made up of four components, used to configure and distribute the user-defined access schemes. One embodiment describing the functioning of each of these components is given herein. Generally, the module 30 is involved with system configuration for PKI via Certificate Services Interface 58, token policies and application and web page training via the DKAXAPI DLL module 48, and generation of one or more client installs via a database, for example an .msi install database (referenced as 96 in FIG. 5) and of the “trained” (i.e. configured) applications database 50 via the module 48. As used hereing, the characterization of a computing resource, such as an application, as “trained” refers to the configuration of the application implementing the present invention (e.g. module DKAXSERVICE.EXE 44) being given information for storage at hard drive or other storage resource(s) 50 to enable the application 44 to recognize the computing resource and effect a login to the resource by populating authentication fields. In turn, the module 48 is responsible for generating and managing the database 50 and policy files and for communication with the smart card hardware modules 28 via the CIP MIDDLEWARE 52 and 54.

In an example Windows platform embodiment as depicted in FIG. 3, the DKLPAHOOK.DLL module 38 is responsible for detecting trained application login events, and, in conjunction with DKAXSERVICE.EXE module 44, assembling all necessary dialogue box or web page information, and controlling and submitting the appropriate login credentials stored on the smart card storage 28A and 28B. The DKAXIE DLL module 40 enables the central DKAXSERVICE.EXE module 44 to connect to the browser to handle logon events by the “trained” (i.e., the DKAXSERVICE module 44 has been given information to recognize) web pages 34. The module 40 also monitors the events of the Client Browser 60, for example, referenced as IE (Internet Explorer), such that when a page load completes or when it is determined the user refreshed a web page. In this monitoring function, the module 40 is the “browser version” of the DKLPAHOOK.DLL module for applications, in this example “dialog,” or Win32 applications, rather than browser-based resources. If the browser is Microsoft's * Internet Explorer browser software, for example, the HWND (window handle) of the Internet Explorer Server control is sent to the central module 44. The DKLPAHOOK DLL module 38 is also an add-in module to enable the central module 44 to connect to the trained corporate applications 62 to handle logon events. Module 38 provides a system-wide scope that generally monitors window creation events. Upon a window creation event, the module 38 sends module 44 the HWND of the window via a Post Message command, when the HWND is relevant to module 44 because module 44 knows something about the window because that window has been “trained” to it as stored in storage 50. This procedure is discussed in greater detail below.

The DKAXIF DLL module 42 may be implemented, for example, as an ActiveX DLL responsible for all communications between the page 32 and the module 48 for policy and database information, as well as between the page 32 and the DKTOOLS DLL module 46 for token initialization, token policy updates, and keys and certificate generation. In turn, the module 46 handles enrollment communications with the CIP MIDDLEWARE modules 52 through 56, and contains a wrapper for all necessary PKCS#11 calls. If PKI is enabled, the module 46 handles all certificate related tasks via the Microsoft ICENROLL DLL module 64. The modules 52, 54, and 56 handle all communication between modules 44, 46, and 48 and the smart card services 66. The modules 52, 54, and 56 are based on client/server architecture and may contain an implementation of the PKCS #11 API and Microsoft Cryptographic Service Provider (CSP) API.

The enrollment page 32 may be implemented to solicit and gather the initial user's smart card passphrase from the user, all passwords and user names required for the trained secured applications 62, the trained web pages 34, and token policies information. In this fashion, the module 44 may further prepare itself to handle all window events (via module 38) and browser page events (via module 40) for all “trained” applications having dialog box logins (Applications 62) or browser page logins (web pages 34). The enrollment 32 page may be implemented to then personalizes the smart card with this information via calls to the modules 42 and 46. SMART LOGON EXE Module 36 enables the user to store passwords and user names of any non-administrator controlled applications and web sites on the smart card, thus providing for user administered configuration of computer resources not supported by an entity's administration or IT personnel. The module 36 interfaces with the smart card via the module 44 that links directly to the CIP middleware component 52. The user name authentication information, and certainly the passwords required to access computing resources, may be stored in the private storage (28B) of the smart card hardware (28, when inserted into a reader/interface). In this manner, the passwords at a minimum will be protected from third party discovery upon misplacement of the removable and more portable element of the hardware combination 28, because access to the secure or private storage 28B is prevented unless the PIN required for such access is provided to the card controller. “Enrollment” generally is the process of providing user-specific authentication information for storage at least in part on secure storage 28B of the smart card hardware 28. This may be effected in a session in which authentication for multiple computing resources are stored, or enrollment may be effected on an “as needed” basis on a per-application basis upon an initial manual sign-on to the computing resource. Most commonly, enrollment will be effected on a per user basis, by the user.

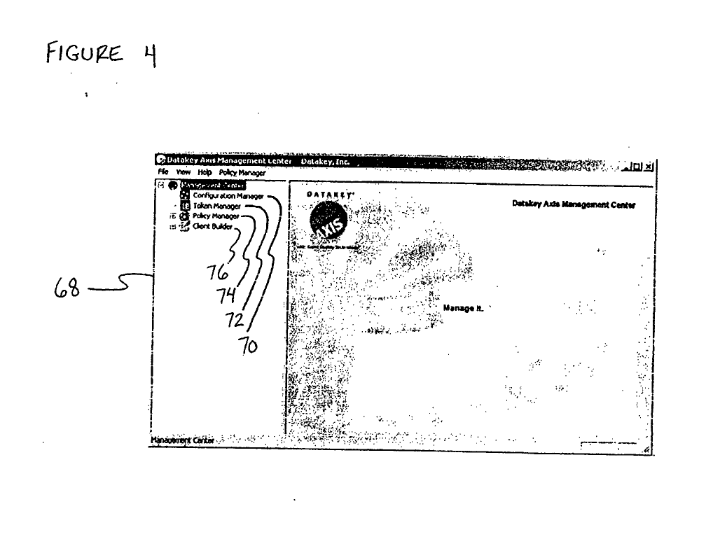

As referenced above, the module 30 utilizes four main components, as shown on screen shot 68 of FIG. 4, in configuring the user-defined access schemes. The components include a configuration manager 70, preferably used to specify a Certificate Authority (CA) that is made available to the system software; a token manager 72, preferably used to define token parameters; a policy manager 74, preferably used to configure the schemes to automatically log the end-user onto the corporate and Web-enabled applications; and a client builder 76, preferably used to specify which system software options to employ and to create one or more schemes. Additionally, a process flow is represented in FIG. 5, which illustrates the four components, and includes function summaries for each. The function summaries for each component are further subdivided into entry module tasks and exit module tasks.

The flowchart of FIG. 5 lays out a plurality of elements 50, 70 through 80, and 84 through 96. While being represented as modules in FIG. 5 and described herein in terms of their functionality, the elements generally involve one or more sections of one or more computer programs of the software package of the administration system. It should be appreciated that there are a number of different ways and fashions in which the software package of the administrative system could be represented, and that this illustrated and described architecture diagram merely represents one such representation.

In using the configuration manager 70, as summarized in entry module 78 of the flowchart of FIG. 5, the administrator preferably specifies the full path name of the CA used by the company to issue digital credentials to the end-users. If a CA is not used at the company (i.e., the company does not use PKI), the field may be left blank. The administrator may also be prompted to specify the location of a local Web site used to host enrollment or enrollment update applications, as also indicated in the entry module 78. Once the tasks in the entry module 78 are completed, exit module 80 involves storing the configuration data into the database 50 (initially referenced in FIG. 3). While database 50 is represented in FIG. 3 as a monolithic disk, it will be appreciated by those skilled in the art that storage of information to the conceptual location 50 may actually involve storage among various files and mediums, and may include, for example, networked storage such as SAN storage, or storage in whole or in part on public portions 28A of card storage. This may permit, for example, more flexible use of the card on other workstations that will provide access to computing resources based on the authentication stored on the removable part of card 28.

In using the token manager 72, as summarized in entry module 84 of the flowchart of FIG. 5, the administrator preferably defines security features and password policy of tokens used by the end-users. Some examples of adjustable parameters that are considered in the entry module 84 include passphrase PIN length, number of failed logon attempts allowed, and timeout duration. Once the tasks in the entry module 84 are completed, exit module 86 involves storing the token policy data into the database 50.

In using the policy manager 74, as summarized in entry module 88 of the flowchart of FIG. 5, the administrator preferably specifies which secured applications will have their access controlled by the system software and which end-users or groups of end-users will have access to each application by linking one or more of the active directory user groups with each application. Additionally, the administrator can configure password policies for the secured applications. Further, the administrator may preferably configure an automatic logon by configuring the schemes to recognize each application's logon dialogue boxes and to automatically log on to each application on behalf of the users. Once the tasks in the entry module 88 are completed, exit module 90 involves storing the scheme data into the database 50.

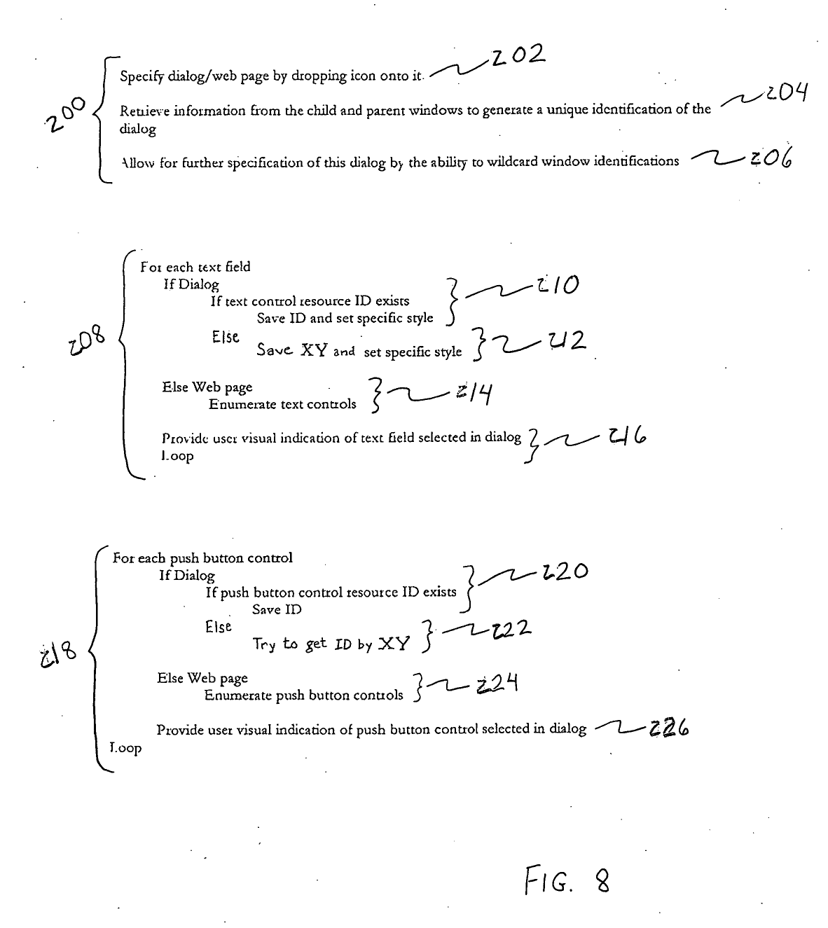

The policy manager 74 is configured with processing intelligence, i.e., algorithms, to dissect the login or change password dialogue boxes for each application and collect the data needed for inclusion into the database 50. As such, the one or more schemes, when distributed to each end-user, are enabled to automatically recognize these dialogue boxes and automatically fill in the appropriate set of user credentials required for a login. There are three main states that the configuration algorithm exists in: 1) TrainingWizardDlg3, 2) TrainingWizardDlg4, and 3) TrainingWizardDlg5. The pseudo code discussed herein with reference to FIG. 8 describes the logical processing flow of these states.

In using the client builder 76, as summarized in entry module 92 of the flowchart of FIG. 5, the administrator is preferably enabled to create the access schemes based upon the configuration information that is drawn from the other three system software components 70, 72, and 74, and this data is then stored in the database 50. The administrator can then uniquely configure each scheme to specify which secured applications will be made available to the users of that particular scheme. Each scheme is created in real time and consists of several different files. As referenced above, each scheme contains a data file that contains the installation information of an application. For example, this may be an .msi file, which is the format used by two of the more popular deployment technologies available today (Microsoft Group Policy® and Microsoft SMS®). Thus, the system software is compatible with these technologies. Once the tasks in the entry module 92 are completed, exit module 94 involves storing the data into a MSI Install Database 96.

In creating the user-defined access schemes using the components described above, the administrative system software allows for much design diversity by the administrator. As such, the system allows the administrator to create one or more user-defined access schemes with a variety of features and varying levels of security for differing groups of end-users. For example, the administrator may create a first scheme having a generalized set of options and distribute it to a first group of users. Subsequently, the administrator may create a second scheme containing a more liberal set of access options and distribute it to a second group of end-users. In comparison, the scheme with the more liberal set of access options may give end-users in the second group a greater number of log-on attempts as well as access to a larger number of secured applications in comparison with the scheme with the generalized set of options. The administrative system also is versatile, as it operates both in PKI and non-PKI environments, which enables the administrator to apply the security technology to a number of different areas within the organization. Additionally, the administrator can manage secured applications through automated policy enforcement that is transparent to the user, control access to such applications by grouping users, enforce strong password policies without user involvement, and prepare/train the target application's password and user ID dialogue boxes for each group using very unique and simple drag and drop techniques to accomplish the task.

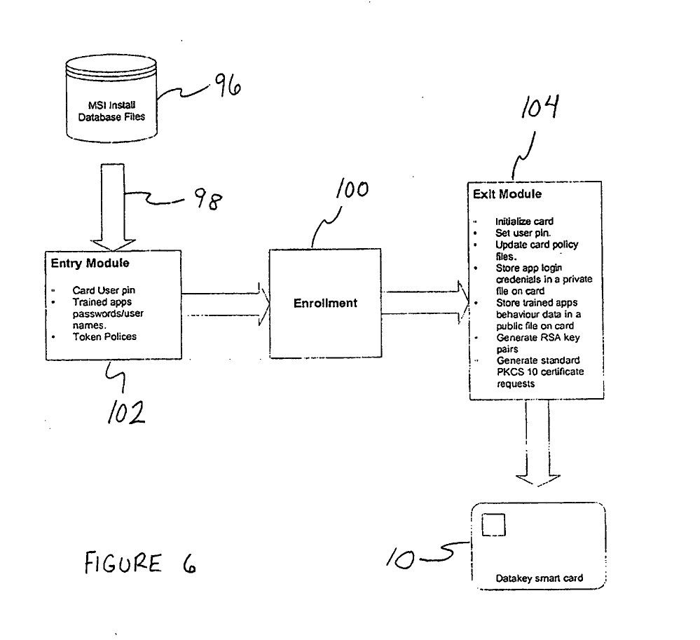

As described above, once created, the one or more user-defined access schemes are distributed to one or more end-user groups. In certain embodiments, the administrative system preferably deploys the schemes from one central location, e.g., the MSI Install database on a workstation or a server, over a network, e.g., a LAN or intemetwork such as the Internet, to the one or more end-user groups. This deployment is generally depicted in FIG. 2, and further represented by step 98 in the process flow depicted in FIG. 6. In other embodiments, the schemes may be distributed more traditionally, e.g., using CD-ROM. After distribution, the scheme will be installed on the workstation, e.g., PC, of the one or more end-users.

To subsequently enroll the one or more of the distributed access schemes, the user must initially enroll his smart card 10. By enrolling, the user personalizes his smart card 10 to the one or more schemes. Additionally, the user's application logon information and any other digital credentials are stored on the smart card 10. This enrollment is generally done only once via the enrollment page 32, depicted as computing resource (e.g. a web page) 32 in FIG. 3. The flowchart represented in FIG. 6 illustrates the enrollment process 100 and includes function summaries for the process. The function summaries for the process are further subdivided into entry module tasks 102 and exit module tasks 104. The flowchart of FIG. 6 lays out a plurality of elements 96 through 104. While being represented in box form in FIG. 6 and described herein in terms of their functionality, the software elements generally involve one or more sections of one or more computer programs of the software package of the administration system. It should be appreciated that there are a number of different ways and fashions in which the software package of the administrative system could be represented, and that this illustrated and described architecture diagram merely represents one such representation.

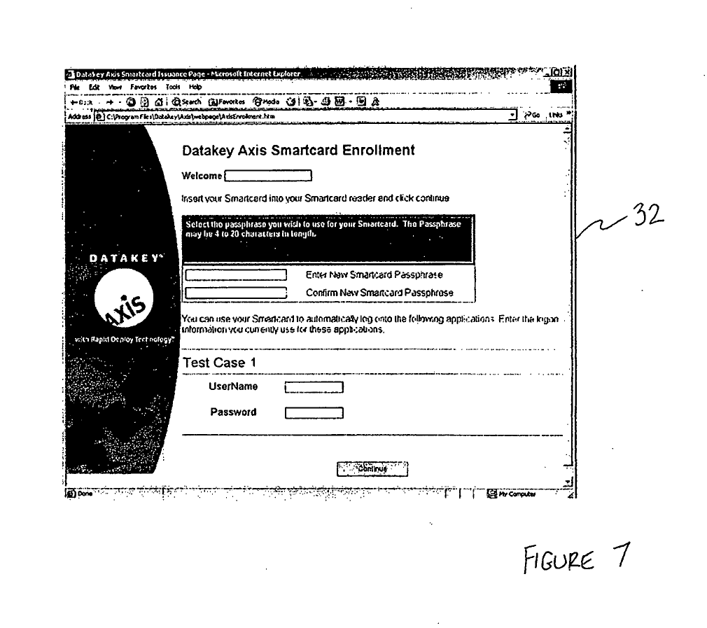

In certain embodiments, in reference to the entry module tasks 102, the user inserts the smart card 10 into a reader (as jointly depicted as element 28 of FIG. 3) connected to the workstation that had previously received and currently runs the distributed scheme. Once the smart card 10 is inserted, the user is prompted to enter his smart card 10 passphrase, e.g., PIN, to log on to the smart card 10. After entering the passphrase, the user activates the enrollment portion of the scheme by generally clicking on a corresponding icon on the screen. Subsequently, a window is displayed, which prompts the user to again enter and confirm the passphrase. This is depicted in FIG. 7 by screen shot 32 (initially referenced in FIG. 3). Once the passphrase is input and confirmed by the user, a link needs to be established between the smart card and each of the secured applications the user has been approved to use. In addition, the system enables a link to be made between the smart card and the other applications the user generally uses, independent of the secured applications. The bottom portion of the enrollment window contains a list of the applications assigned and approved by the administrator to work with the smart card 10 (only one application, i.e., Test Case 1, is depicted in the screen shot 32 of FIG. 7). To establish the link, the user must input the logon information that he currently uses when logging on to each of the listed applications.

Once the smart card passphrase and log-on information for each application are entered, the exit module tasks 104 are subsequently initiated. These tasks include initializing the smart card 10, setting the user pin, updating the smart card policy files, storing the application log-on credentials in a private file on the smart card 10, storing trained application behavior data in a public file on the smart card 10, generating RSA key pairs, and generating standard PKCS 10 certificate requests. Upon completion of the exit module tasks 104, the smart card 10 is ready to be used with the distributed scheme.

Once created by such configuration and enrollment procedures, the access scheme can be subsequently utilized by the end-user. In turn, the access scheme will automatically log on the user to each secured application that is approved for the end-user. As such, the scheme recognizes the individual fields on the login dialogue boxes of the secured applications (and other applications accessed by the user, if applicable) and automatically provides the correct information for these fields during the user login process. In turn, logins to these applications become automatic and invisible to the user. The scheme may also be created to recognize password change screens and the individual fields on the password dialogue boxes of the secured applications and automatically provide new passwords for these fields during the password change process. When these mechanisms are both used, the password-based logon process becomes that much more secure since the users do not know the passwords used to log on to the application, the passwords can be stricter or stronger, and change password/freshness policies are more easily enforced. A suitable implementation of the functionality of the configuration module 30 of FIG. 3, as well as of the DKLPAHOOK.DLL module 38 and DKAXIE ADDIN.DLL (or DKAXIE) module 40 is outlined in FIGS. 8, 9, and 10 respectively, using a pseudo-code not dependent on any particular programming language.

The administrative system software includes the Axis Management Center module 30, which is generally utilized by the administrator. The module 30 is used in configuring or designing the user access schemes which may be loosely regarded as “training” the central application 48 to handle dialog or browser login events. Following their configuration using the module 30, the access schemes are able to identify a secured application of type 62 through a recognition of dialog boxes of the secured application related to logins. The dialog boxes generally include one or more text boxes of other controls such as buttons, which may be intended for username, password, or other authentication information. The recognition of the dialog boxes is based on locating identifying information of the dialog boxes and subsequently saving this information in the Trained Apps Database 50. The locating and saving of such identifying information of the dialog boxes is accomplished by using the functions of administrative module 30.

The module 30 can be made up a plurality of sub modules or routines. In certain embodiments, the module 30 has four sub modules. Such sub modules may be generally referenced as the configuration manager, the token manager, the policy manager, and the client builder. The functioning of each sub module is described herein. With respect to configuring the access schemes to recognize a secured application by associating the application with certain identifying information of dialog boxes as discussed herein, the policy manager is used.

FIG. 8 depicts pseudo-code for portions of the computer program which are used in implementing the policy manager. In one part 200 of the pseudo-code of the policy client 74, the administrator identifies the dialog boxes of the secured applications. By dropping an icon onto a dialog/web page of the secured applications in step 202, the dialog/web page can be specified, i.e. added, to the access scheme. Identifying information (e.g., information about the child and/or parent windows to the dialog window) is retrieved in step 204 to generate a unique identification of dialog boxes on the dialog/web page. In certain embodiments of the invention, the unique identification is the window's window title text. Further information can be retrieved from the dialog/web page to allow for further specification. As indicated in step 206, further information may include wildcard dialog/web page identifications, where the title texts may change, allowing for identification with respect to the dialog boxes where the title text changes dynamically (e.g., according to a session ID).

In another part 208 of the pseudo-code of the policy client 74, the administrator identifies the text information of the dialogue boxes previously identified for the dialog/web page. Generally, since dialog windows may often be implemented in a Microsoft®-based environment, a text control resource ID is often found to exist and can be used to identify the text field; however, if a text control resource ID does not exist, the text field can also be identified by the control's X and Y coordinates. In summary, for each text field of the dialog boxes identified in the pseudo-code part 200, there is a procedure for locating and saving its corresponding identification information. In step 210, if a dialog window has a text control resource ID, the text control resource ID is saved. In certain embodiments, a specific style designation is also set and saved to help further differentiate the text control (text field). In step 212, if a dialog window has a text control without a resource ID, the X and Y coordinates of the control are saved. Again, in certain embodiments, a specific style designation may also be stored. In step 214, if the computer resource is implemented as a web page, the text field is identified by enumeration of the various text controls by their programmed name. Finally, in step 216, the user would be provided with some sort of visual indication to indicate the specific text field being selected (e.g., flashing string of asterisks, or the like).

In another part 218 of the pseudo-code of the policy client 74, the administrator identifies the push button control of the dialog boxes, previously identified for the dialog/web page. Similar to part 208 of the pseudo-code of the policy client 74, since a dialog window may typically be Microsoft®-based, a push button control resource ID is often found to exist and can be used to identify the push button control; however, if a push button control resource ID does not exist, the push button control can also be identified by X and Y coordinates. In summary, for each push button control of the dialogue boxes identified in the pseudo-code part 200, there is a procedure for locating its corresponding identification information. In step 220, if the module is dealing with dialog window, and a push button control resource ID exists, the push button control resource ID is stored to database 50 of FIG. 3. In step 222, if the module is being trained on a dialog window but no push button control resource ID exists, the X and Y coordinates of the control (push button) are saved. In step 224, if the resource requiring login is a web page, the push button control would be identified by enumeration of programmed names. Finally, in step 226, the user would be provided with some sort of visual indication to indicate the specific push button control being selected (e.g., flashing of the interface (here, a button)).

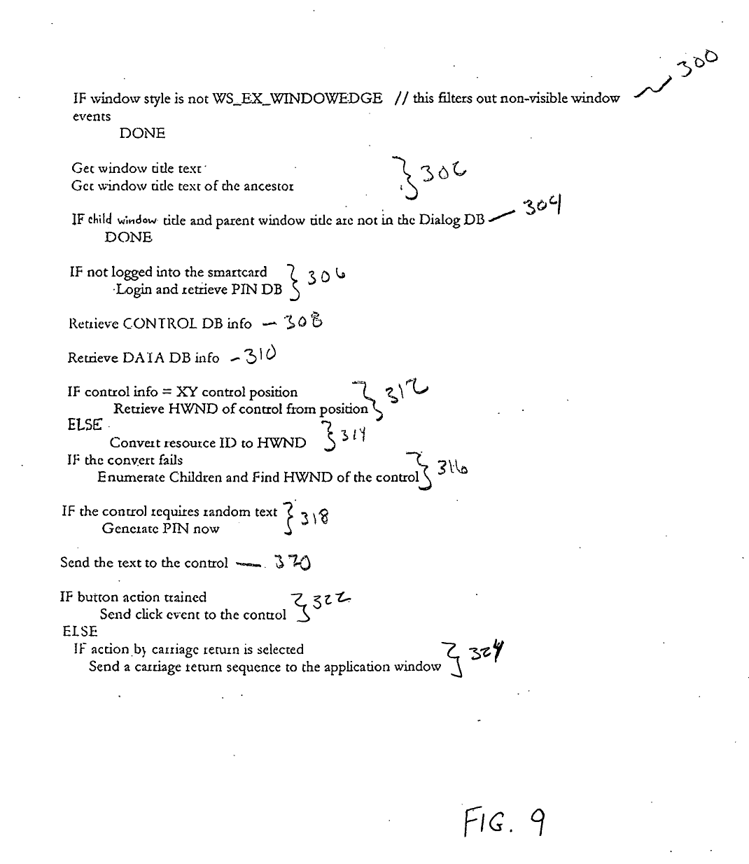

With reference to FIG. 9, pseudo-code for portions of the computer program that are used in running the DKLPAHOOK module is shown. As discussed above, DKLPAHOOK DLL module 38 is a module to enable module 44 to monitor the trained corporate applications 62 to handle logon events propagated by the application 62. Module 38 provides a system-wide scope that monitors possible logon events, e.g. window-creation events in a windows environment. At state 300 the program determines the window style and filters out any non-visible windows. The program then gets the window title text of the window and any ancestor (i.e., spawning) window of the window being monitored at state 302. At state 304, the program determines whether the child (monitored) window or the parent window is in dialog database 50. If they are not, then the module terminates. The program then determines whether the user is logged into smart card 10 and if not, then the program will prompt card login and retrieve the PIN from the PIN database at state 306. The module also retrieves the control database information from configuration database 50 (state 308) and retrieves data database information from smart card 10 (state 310). At state 312, the program determines whether the control data is an XY control position and if so, the program retrieves the window handle (HWND) of the control, the control being typically a text entry box, or GUI button. If the stored control is not a coordinate (i.e., XY) position, then the program converts the resource ID to HWND at state 314 via a standard API call. If the conversion of Resource 10 to windows handle fails, then the program enumerates the children windows, and by company child information against the stored configuration information, determines the HWND of the control at state 316. At state 318, if the control requires random text (such as a new password), then the program generates a PIN for use. The PIN is then sent to the control at state 320 and also stored in the private section 28B of smart card 28 in FIG. 3. At state 322, if button action is trained, then the event to sent to the control. However, if action by a carriage return is selected, then a carriage return sequence is sent to the application window at state 324.

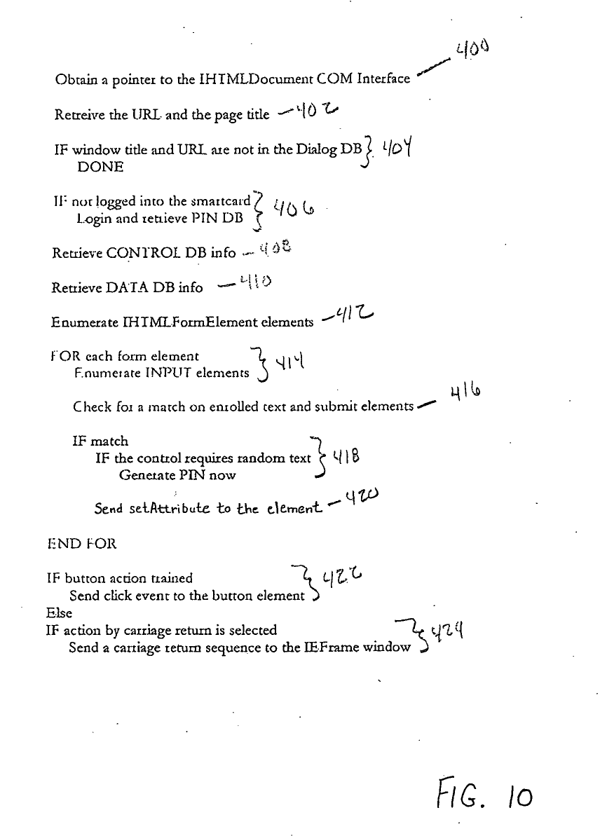

With reference to FIG. 10, pseudo-code for portions of the computer program that may be used in implementing the DKAXIE module is shown. As stated above, the DKAXIE module 40 is a module to enable module 44 to connect to browser 60 to handle logon events by the trained web pages 34. Generally, the DKAXIE module 40 is analogous to module DKLPAHOOK 38, which handles window propagation to detect trained logins. Similarly, DKAXIE module 40 detects web page propagation for known login environments. At state 400, the program obtains a pointer to the IHTMLDocument interface. The URL and page title are then retrieved at state 402. If the page title and URL are not in the trained app database 50 of FIG. 3, then the module is terminated as to that page at state 404. However, if the page title and URL are in the app database 50 of FIG. 3, the program determines whether the user is logged into smart card 10 and if so, the program retrieves the corresponding authentication information from the PIN database at state 406. This includes retrieving the control identification information from trained app database 50 of FIG. 3 (state 408), retrieving authentication information from smart card 10 (state 410), and enumerating IHTMLFormElement elements to inventory the form inputs for which login information is required (state 412). For each form element the program enumerates INPUT elements (state 414). The program then checks for a match with enrolled text and, if a match exists, submits the corresponding text to the element (state 416). If a match is found, and if the control requires random text, then a PIN is generated (state 418). However, if the control does not require random text, then the set attribute (i.e., the corresponding authentication information) is sent to the element (state 420). At state 422, if button action is trained, then the click event is sent to the control. However, if action by a carriage return is selected, then a carriage return sequence is sent to the application window at state 424.

While embodiments of the present invention have been described, it should be understood that various changes, adaptations, and modifications may be made therein without departing from the spirit of the invention and the scope of the appended claims.

1. A system for managing user access to one or more secured applications, the system comprising:
a) at least first and second processing devices;
b) one or more portable access devices having information stored therein, each portable access device adapted to facilitate two-way communication with the first processing device; and
c) an access scheme adapted to be configured with one of the first and second processing devices and adapted to be enrolled by a user following such configuration with the first processing device, the access scheme following such configuration and enrollment adapted to facilitate user access to the one or more secured applications when used with the first processing device.

2. The system of claim 1, wherein the at least first and second processing devices are linked by a network.

3. The system of claim 2, wherein the access scheme is adapted to be configured with the second processing device and adapted to be deployed from the second processing device to the first processing device via the network.

4. The system of claim 2, wherein the network comprises a local area network.

5. The system of claim 1, wherein at least one of the processing devices comprises a CPU in a personal computer.

6. The system of claim 1, wherein the portable access devices comprise smart cards.

7. The system of claim 1, wherein the two-way communication comprises read and write capability.

8. The system of claim 1, further comprising an interface that links the portable access devices with the first processing device and enables the two-way communication.

9. The system of claim 8, wherein the interface comprises a reader of the portable access devices, wherein the reader is electrically connected to the first processing device.

10. The system of claim 1, wherein the portable access devices are configured to authenticate the user before access is provided to the information stored in the portable access devices.

11. The system of claim 10, wherein the portable access devices are configured to authenticate the user from a pass phrase provided by the user.

12. The system of claim 10, wherein the access scheme following such configuration and enrollment is configured to automatically prompt the user for authentication information when encountering the one or more secured applications.

13. The system of claim 1, wherein the one or more secured applications are specified during the configuration of the access scheme.

14. The system of claim 1, wherein the access scheme is adapted to facilitate user access to the one or more secured applications by being configured to automatically recognize log-on dialogue box fields of the one or more secured applications and be being enrolled to automatically recognize and enter the corresponding information stored in the portable access devices into the log-on dialogue box fields.

15. The system of claim 14, wherein the access scheme is configured to automatically recognize the log-on dialogue box fields of the one or more secured applications by dragging and dropping the log-on dialogue box fields of the one or more secured applications to the access schemes during the configuration of the access scheme.

16. The system of claim 14, wherein the access scheme is enrolled to automatically recognize and enter the corresponding information stored in the portable access devices into the log-on dialogue box fields by logging on to the one or more secured applications using the corresponding information stored in the portable access devices during the enrollment of the access scheme with the first processing device.

17. A system for managing user identity to one or more secured applications, the system comprising:
a) at least first and second processing devices;
b) one or more access devices having information stored therein, each access device adapted to facilitate two-way communication with the first processing device; and
c) an access scheme adapted to be configured with one of the first and second processing devices and adapted to be enrolled following such configuration with the first processing device, the access scheme following such configuration and enrollment adapted to change the information stored in the access devices when necessitated by the one or more secured applications when used with the first processing device.

18. The system of claim 17, wherein the at least first and second processing devices are linked by a network.

19. The system of claim 18, wherein the access scheme is adapted to be configured with the second processing device and adapted to be deployed from the second processing device to the first processing device via the network.

20. The system of claim 18, wherein the network comprises a local area network.

21. The system of claim 17, wherein the processing devices comprise personal computers.

22. The system of claim 17, wherein the access devices comprise portable devices.

23. The system of claim 22, wherein the access devices comprise smart cards.

24. The system of claim 17, wherein the two-way communication comprises read and write capability.

25. The system of claim 17, further comprising an interface that links the access devices with the first processing device and enables the two-way communication.

26. The system of claim 25, wherein the interface comprises a reader of the access devices, wherein the reader is electrically connected to the first processing device.

27. The system of claim 17, wherein the access devices are configured to authenticate the user before access can be provided to the information stored in the portable access devices.

28. The system of claim 27, wherein the access devices are configured to authenticate a pass phrase when entered by the user.

29. The system of claim 27, wherein the access scheme following such configuration and enrollment is configured to automatically prompt the user for authentication information when encountering the one or more secured applications.

30. The system of claim 17, wherein the one or more secured applications are specified during the configuration of the access scheme.

31. The system of claim 17, wherein the access scheme is adapted to change the information stored in the access devices by being configured to automatically recognize information change requests of the one or more secured applications and by being enrolled to automatically recognize and change the corresponding information that is stored in the access devices and normally entered in corresponding log-on dialogue box fields of the one or more secured applications.

32. The system of claim 31, wherein the access scheme is configured to automatically recognize the information change requests of the one or more secured applications by dragging and dropping the log-on dialogue box fields from the one or more secured applications to the access schemes during the configuration of the access scheme.

33. The system of claim 31, wherein the access scheme is enrolled to automatically recognize and change the corresponding information stored in the access devices into the log-on dialogue box fields by logging on to the one or more secured applications using the corresponding information stored in the access devices during the enrollment of the access scheme with the first processing device.

34. A method of creating a system to manage user access to one or more secured applications, the method comprising the steps of:
a) providing at least first and second processing devices;
b) providing one or more portable access devices having information stored therein, each portable access device adapted to facilitate two-way communication with the first processing device; and
c) configuring an access scheme with one of the first and second processing devices;
d) enrolling the access scheme with the first processing device; and
e) facilitating user access to the one or more secured applications with the access scheme following such configuration and enrollment when the access scheme is used with the first processing device.

35. The method of claim 34, further comprising linking the at least first and second processing devices by a network.

36. The method of claim 35, wherein the configuring step further includes deploying the access scheme from the second processing device to the first processing device via the network following configuration of the access scheme with the second processing device.

37. The method of claim 34, further comprising providing an interface that links the portable access devices with the first processing device and enables the two-way communication.

38. The method of claim 37, wherein the interface comprises a reader of the portable access devices, wherein the providing the interface step further includes connecting electrically the reader to the first processing device.

39. The method of claim 34, further comprising the step of authenticating the user to the portable access devices before access is provided to the information stored in the portable access devices.

40. The method of claim 39, wherein the authenticating step further includes authenticating the user by a pass phrase provided by the user.

41. The method of claim 39, further comprising the step of prompting automatically by the access scheme authentication information from the user when encountering the one or more secured applications following such configuration and enrollment.

42. The method of claim 34, wherein the configuring step further includes specifying the one or more secured applications when the access scheme is configured.

43. The method of claim 34, wherein the configuring step further includes configuring the access scheme to automatically recognize log-on dialogue box fields of the one or more secured applications and enrolling the access scheme to automatically recognize and enter the corresponding information stored in the portable access devices into the log-on dialogue box fields.

44. The method of claim 43, wherein enrolling the access scheme to automatically recognize log-on dialogue box fields of the one or more secured applications further includes dragging and dropping the log-on dialogue box fields of the one or more secured applications to the access scheme during the configuration of the access scheme.

45. The method of claim 43, wherein configuring the access scheme to automatically recognize and enter the corresponding information stored in the portable access devices into the log-on dialogue box fields further includes logging on to the one or more secured applications using the corresponding information stored in the portable access devices during the enrollment of the access scheme with the first processing device.

46. A method of creating a system to manage user identity to one or more secured applications, the method comprising the steps of:
a) providing at least first and second processing devices;
b) providing one or more access devices having information stored therein, each access device adapted to facilitate two-way communication with the first processing device; and
c) configuring an access scheme with one of the first and second processing devices;
d) enrolling the access scheme with the first processing device; and
e) changing the information stored in the access devices when necessitated by the one or more secured applications with the access scheme following such configuration and enrollment when the access scheme is used with the first processing device.

47. The method of claim 46, wherein the one or more access devices comprise portable devices.

48. The method of claim 46, further comprising linking the at least first and second processing devices by a network.

49. The method of claim 48, wherein the configuring step further includes deploying the access scheme from the second processing device to the first processing device via the network following configuration of the access scheme with the second processing device.

50. The method of claim 46, further comprising providing an interface that links the access devices with the first processing device and enables the two-way communication.

51. The method of claim 50, wherein the interface comprises a reader of the access devices, wherein providing the interface step further includes connecting electrically the reader to the first processing device.

52. The method of claim 46, further comprising the step of authenticating the user to the access devices before access is provided to the information stored in the access devices.

53. The method of claim 52, wherein the authenticating step further includes authenticating the user by a pass phrase provided by the user.

54. The method of claim 52, further comprising the step of prompting automatically by the access scheme authentication information from the user when encountering the one or more secured applications following such configuration and enrollment.

55. The method of claim 46, wherein the configuring step further includes specifying the one or more secured applications when the access scheme is configured.

56. The method of claim 46, wherein the configuration step further includes configuring the access scheme to automatically recognize information change requests of the one or more secured applications and enrolling the access scheme to automatically recognize and change the corresponding information that is stored in the access devices and normally entered in corresponding log-on dialogue box fields of the one or more secured applications.

57. The system of claim 56, wherein configuring the access scheme to automatically recognize the information change requests of the one or more secured applications further includes dragging and dropping the log-on dialogue box fields of the one or more secured applications to the access scheme during the configuration of the access scheme.

58. The system of claim 56, wherein enrolling the access scheme to automatically recognize the corresponding information that is stored in the access devices and normally entered in the corresponding log-on dialogue box fields further includes logging on to the one or more secured applications using the corresponding information stored in the access devices during the enrollment of the access scheme with the first processing device.

59. A system for managing user access to one or more secured computing resources, the system comprising:
a) at least first and second processing devices;
b) one or more portable access devices having information stored therein, each portable access device adapted to facilitate two-way communication with the first processing device; and
c) an access scheme adapted to be configured with one of the first and second processing devices and adapted to be enrolled by a user following such configuration with the first processing device, the access scheme following such configuration and enrollment adapted to facilitate user access to the one or more secured computer resources when used with the first processing device.

60. The system of claim 59, wherein the computing resource is executable code.

61. The system of claim 59, wherein the computing resource is at least one HTML page.
